(19) United States
(12) Patent Application Publication
(10) Pub. No.: US 2009/0215437 A1
(43) Pub. Date: Aug. 27, 2009

(54) METHOD AND APPARATUS FOR OVERRIDING A CALL FORWARDING SERVICE OF A MOBILE DEVICE

(75) Inventor: Jian Hua Hou, Beijing (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/038,023

(22) Filed: Feb. 27, 2008

(51) Int. Cl. H04M 3/42

(52) U.S. Cl. 455/417

(57) ABSTRACT

A method for overriding a call forwarding service of a mobile device enables enhanced call forwarding services. The method includes transmitting a first send routing information message from a mobile switching center to a home location register (step 305). The mobile switching center then processes a first send routing information acknowledgement message (step 310). The first send routing information acknowledgment message includes location information of a call forwarding number of the mobile device. The mobile switching center then determines that a call to the call forwarding number of the mobile device was not answered (step 315). A second send routing information message is then transmitted from the mobile switching center to the home location register (step 320). Finally, the mobile switching center processes a second send routing information acknowledgement message that includes location information of the mobile device (step 325).

### FIELD OF THE INVENTION

The present invention relates generally to mobile communication devices, and in particular, but not exclusively, to overriding a call forwarding service of a mobile telephone after a call to a call forwarding number is not answered.

### BACKGROUND

In some public land mobile networks (PLMNs), such as in a Global System for Mobile (GSM) communications network, calls are routed to mobile devices operating in the network using home location registers (HLRs). The HLRs store data about where in the network a particular mobile device is operating. When a mobile device roams to a new radio access network (RAN) node, the mobile device connects to a mobile switching center (MSC) associated with that RAN node. The MSC identifies the mobile device and informs an HLR associated with the mobile device that the mobile device is now currently in wireless communication with the MSC. If an incoming call directed to the mobile device is then received in the network, the network first contacts the HLR associated with the mobile device to learn the identity of the MSC that is currently managing wireless communication with the mobile device. The incoming call is then routed through the MSC to the mobile device.

GSM also supports various optional communication services for subscribers. Some optional services can be provisioned using supplementary service (SS) codes, such as defined in the Third Generation Partnership Project (3GPP) technical specification (TS) 29.002. For example, a supplementary service named call forwarding unconditional (CFU) enables calls to a telephone number of a mobile device to be forwarded to another telephone number associated with another device, such as a public switched telephone network (PSTN) telephone or another mobile device.

When a CFU SS is activated for a mobile device, all calls to the mobile device will be forwarded to a call forwarding number that was previously defined by a user of the mobile device. When an MSC subsequently receives a request from a caller to establish a call to the mobile device, the MSC will transmit a send routing information (SRI) message to an HLR associated with the mobile device. The HLR will then transmit an SRI acknowledgement (SRI ACK) message back to the MSC, where the SRI ACK message includes location information for the call forwarding number. The MSC then routes the call to the call forwarding number.

However, if the call to the call forwarding number is not answered, the call will be automatically released. Such an automatic release of a call to a call forwarding number can be undesirable, particularly where a user of the mobile device that defined the call forwarding number is reachable at the mobile device. There is therefore a need for an improved method and apparatus for overriding a call forwarding service of a mobile device.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a message sequence chart illustrating a series of messages that are exchanged in a wireless communication network to enable registration of a call forwarding override supplementary service, according to some embodiments of the present invention.

FIG. 2 is a message sequence chart illustrating a method for overriding a call forwarding service of a mobile device, according to some embodiments of the present invention.

FIG. 3 is a general flow diagram illustrating a method for overriding a call forwarding service of a mobile device, according to some embodiments of the present invention.

FIG. 4 is a block diagram illustrating components of a mobile switching center (MSC), according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to overriding a call forwarding service of a mobile device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

According to one aspect, the present invention is a method for overriding a call forwarding service of a mobile device. The method includes transmitting a first send routing information message from a mobile switching center to a home location register, where the send routing information message requests routing information for the mobile device in response to a call to the mobile device. The mobile switching center then processes a first send routing information acknowledgement message, where the first send routing information acknowledgment message is received from the home location register in response to the first send routing information message. The first send routing information acknowledgment message includes location information of a call forwarding number of the mobile device. The mobile switching center then determines, in response to the first send routing information acknowledgement message, that a call to the call forwarding number of the mobile device was not answered. A second send routing information message is then transmitted from the mobile switching center to the home location register in response to determining that the call to the call forwarding number of the mobile device was not answered. Finally, the mobile switching center processes a second send routing information acknowledgement message, where the second send routing information acknowledgement message is received from the home location register in response to the second send routing information message and includes location information of the mobile device.

Some embodiments of the present invention therefore enable a mobile switching center (MSC) to override a call forwarding service of a mobile device to enable a forwarded call to be rerouted back to the mobile device. That can be beneficial in various circumstances. For example, if a user of a mobile device is working for a period of time in an office location, the user may choose to forward, using a call forwarding supplementary service, all calls to the user's mobile device to a landline telephone in the office that is connected to a public switched telephone network (PSTN). However, if the user then leaves the office momentarily, for example to attend a meeting or go out to lunch, it is not necessary for the user to switch off the call forwarding supplementary service. Rather, using an implementation of the present invention, all calls forwarded to the landline telephone from the mobile device that are unanswered will be automatically rerouted back to the mobile device. That provides increased convenience for mobile device users and additional revenue opportunities for network operators.

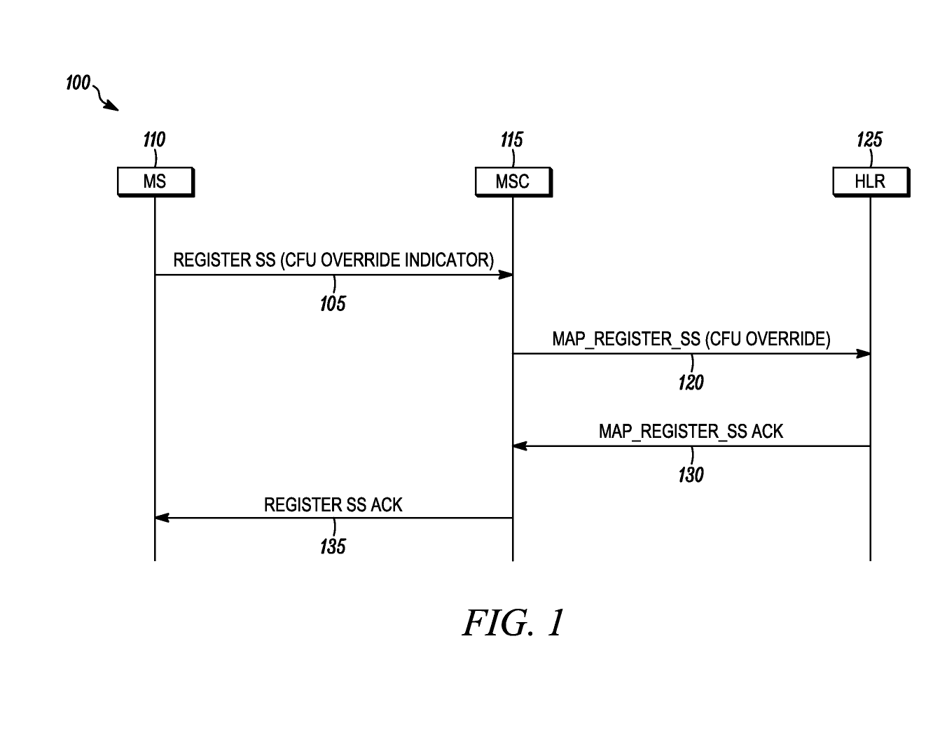

Referring to FIG. 1, a message sequence chart illustrates a series of messages that are exchanged in a wireless communication network 100 to enable registration of a call forwarding override supplementary service, according to some embodiments of the present invention. For example, the series of messages may conform to a Third Generation Partnership Project (3GPP) technical specification (TS) concerning open system interface (OSI) layer 3 messages for supplementary services.

A register supplementary service (RegisterSS) message 105 is first transmitted from a mobile device such as a mobile station (MS) 110 to a mobile switching center (MSC) 115. The MSC 115 then transmits a mobile application part (MAP) protocol register supplementary service (MAP register SS) message 120 to a home location register (HLR) 125 associated with the MS 110. Both the RegisterSS message 105 and the MAP register SS message 120 include a call forwarding unconditional (CFU) override indicator that indicates that the MS 110 has activated a call forwarding override supplementary service.

Below is an example of pseudo code, using Abstract Syntax Notation One (ASN.1), which can be executed at both the MS 110 and at the MSC 115 to register a call forwarding unconditional (CFU) override supplementary service, according to some embodiments of the present invention:

```
SS-Protocol{ 0 identified-organization (4) etsi (0) mobileDomain (0) gsm-Access (2)
modules (3) ss-Protocol (3) version7 (7) }
DEFINITIONS
::=
BEGIN
registerSS OPERATION
  ARGUMENT
    registerSS-Arg SEQUENCE {
```

| | |
|---|---|
| ss-Code | OCTET STRING ( SIZE (1 ) ), |
| basicService | CHOICE { |

| | |
|---|---|
| bearerService | [2] IMPLICIT OCTET STRING ( SIZE (1 ) ), |
| teleservice | [3] IMPLICIT OCTET STRING ( SIZE (1 ) )} OPTIONAL, |

| | |
|---|---|
| forwardedToNumber | [4] IMPLICIT OCTET STRING ( SIZE (1 .. 20 ) ) |
| OPTIONAL, | |
| forwardedToSubaddress | [6] IMPLICIT OCTET STRING ( SIZE (1 .. 21 ) ) |
| OPTIONAL, | |

| | |
|---|---|
| CFU-Override | [10] IMPLICIT OCTET STRING ( SIZE (1 ) ), |

| | |
|---|---|
| noReplyConditionTime | [5] IMPLICIT INTEGER ( 5 .. 30 ) OPTIONAL, |
| ... , | |
| defaultPriority | [7] IMPLICIT INTEGER ( 0 .. 15 ) OPTIONAL, |
| nbrUser | [8] IMPLICIT INTEGER ( 1 .. 7 ) OPTIONAL, |
| longFTN-Supported | [9] IMPLICIT NULL OPTIONAL} |

After receiving the MAP_register_SS_message 120, the HLR 125 transmits a MAP_register_SS acknowledgement (ACK) message 130 back to the MSC 115. Finally, the MSC 115 transmits a RegisterSS ACK message 135 back to the MS 110.

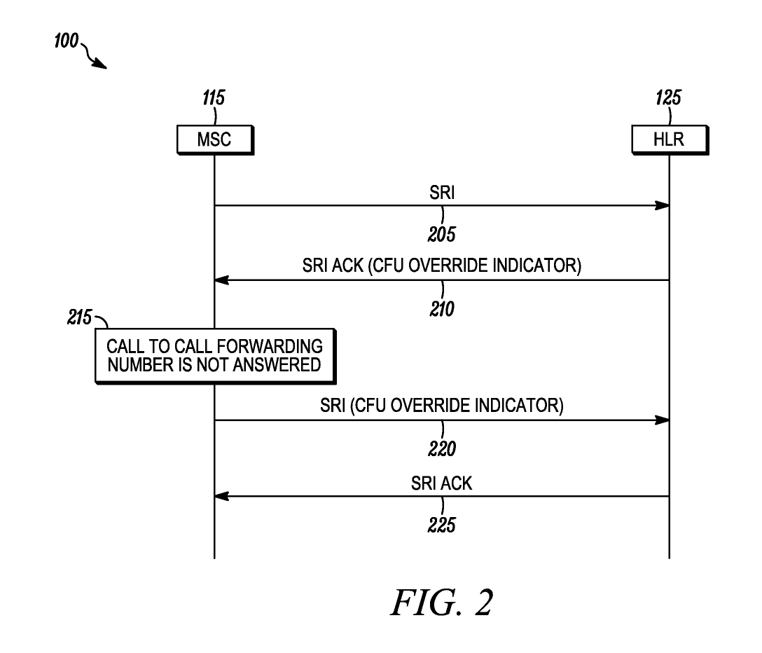

Referring to FIG. 2, a message sequence chart illustrates a method for overriding a call forwarding service of a mobile device, according to some embodiments of the present invention. Consider that the MS 110 has already completed a registration process for a CFU supplementary service and for a CFU override supplementary service. Further, consider that the MSC 115 has subsequently received a request from a third party caller to establish a call to the MS 110. The MSC 115 therefore transmits a send routing information (SRI) message 205 to the HLR 125. The HLR 125 then responds with an SRI ACK message 210 that includes location information of a call forwarding number of the MS 110 and an indicator, such as an information element, that indicates that a CFU override supplementary service is presently active.

At block 215, the MSC 115 processes the SRI ACK message 210 and then attempts to establish a call with the call forwarding number of the MS 110. However, consider that the call to the call forwarding number is not answered. The MSC 115 then transmits a second SRI message 220 to the HLR 125, where the second SRI message 220 includes a CFU override indicator, such as an information element. The second SRI message 220 thus informs the HLR 125 that the call to the call forwarding number of the MS 110 was not answered. The HLR 125 therefore overrides the CFU supplementary service and transmits a second SRI ACK message 225 to the MSC 115, where the second SRI ACK message 225 includes location information of the MS 110. The MSC 115 is then able to route the call back to the MS 110.

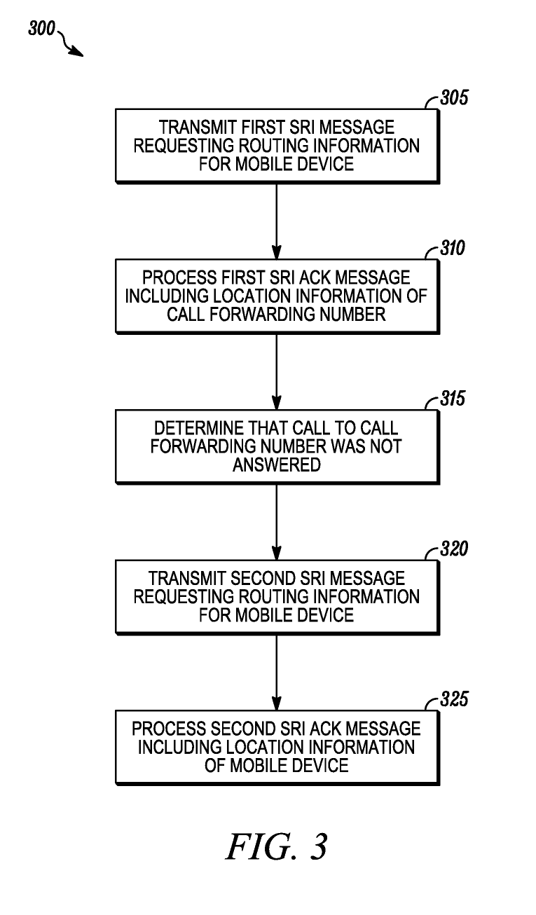

Referring to FIG. 3, a general flow diagram illustrates a method 300 for overriding a call forwarding service of a mobile device, according to some embodiments of the present invention. At step 305, a first send routing information message is transmitted from a mobile switching center to a home location register, wherein the send routing information message requests routing information for the mobile device in response to a call to the mobile device. For example, as shown in FIG. 2, the SRI message 205 is transmitted from the MSC 115 to the HLR 125.

At step 310, the mobile switching center processes a first send routing information acknowledgement message, wherein the first send routing information acknowledgment message is received from the home location register in response to the first send routing information message and includes location information of a call forwarding number of the mobile device. For example, the MSC 115 processes the SRI ACK message 210 received from the HLR 125 in response to the SRI message 205.

At step 315, the mobile switching center determines, in response to the first send routing information acknowledgement message, that a call to the call forwarding number of the mobile device was not answered. For example, at block 215, the MSC 115 determines that a call to the call forwarding number of the MS 110 was not answered. Such a determination can be made, for example, after a predetermined number or “rings” at the call forwarding number, or by determining that a predetermined time period has expired since the call to the call forwarding number was made.

At step 320, a second send routing information message is transmitted from the mobile switching center to the home location register in response to determining that the call to the call forwarding number of the mobile device was not answered. For example, the MSC 115 transmits the second SRI message 220 to the HLR 125 in response to determining that the call to the call forwarding number of the MS 110 was not answered.

At step 325, the mobile switching center processes a second send routing information acknowledgement message, wherein the second send routing information acknowledgement message is received from the home location register in response to the second send routing information message and includes location information of the mobile device. For example, the MSC 115 processes the second SRI ACK message 225 received from the HLR 125 in response to the second SRI message 220. The MSC 115 thus overrides a CFU supplementary service of the MS 110 and is able to reroute a forwarded call back to the MS 110.

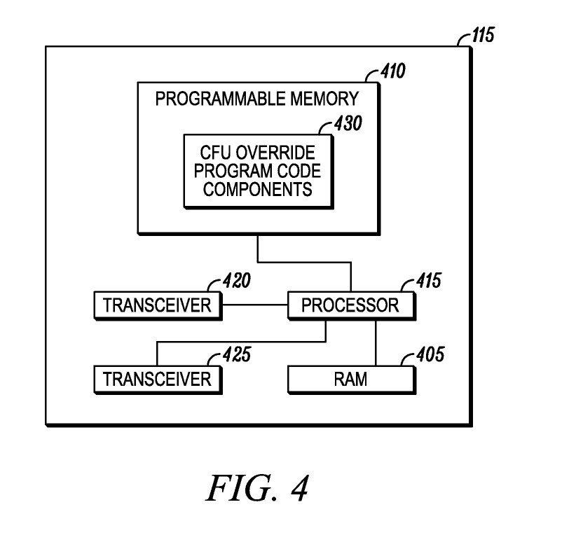

Referring to FIG. 4, a block diagram illustrates components of the mobile switching center (MSC) 115 operating in the wireless communication network 100, according to some embodiments of the present invention. The MSC 115 comprises a random access memory (RAM) 405 and a programmable memory 410 that are coupled to a processor 415. The processor 415 also has ports for coupling to transceivers 420, 425. The transceivers 420, 425 can be used to enable the MSC 115 to communicate with other network devices, such as the MS 110 or the HLR 125, which operate using various communication technologies, protocols and frequencies. For example, the transceiver 420 can be used to communicate with the MS 110 using a global system for mobile (GSM) or code division multiple access (CDMA) technology; whereas the transceiver 425 can be used to communicate with the HLR 125 using an alternative communication technology.

The programmable memory 410 can store operating code (OC) for the processor 415 and code for performing functions associated with registration and processing of supplementary services. For example, the programmable memory 410 can comprise CFU override computer readable program code components 430 configured to cause execution of the method 300 for overriding a call forwarding service of a mobile device as described herein.

Advantages of the present invention thus include enabling calls to a mobile device that are forwarded to a call forwarding number to be rerouted back to the mobile device if there is no answer at the call forwarding number. That can provide increased convenience for mobile device users, because it can increase the likelihood that a call to a number associated with the user will be answered, and because call forwarding supplementary services do not need to be switched on and off if the user occasionally moves away from a phone associated with the call forwarding number.

It will be appreciated that embodiments of the invention described herein may be comprised of one or more conventional processors and unique stored program instructions that control the one or more processors to implement, in conjunction with certain non-processor circuits, some, most, or all of the functions of overriding a call forwarding service of a mobile device as described herein. The non-processor circuits may include, but are not limited to, a radio receiver, a radio transmitter, signal drivers, clock circuits, power source circuits, and user input devices. As such, these functions may be interpreted as steps of a method for overriding a call forwarding service of a mobile device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for overriding a call forwarding service of a mobile device, the method comprising:
transmitting a first send routing information message from a mobile switching center to a home location register, wherein the send routing information message requests routing information for the mobile device in response to a call to the mobile device;
processing at the mobile switching center a first send routing information acknowledgement message, wherein the first send routing information acknowledgment message is received from the home location register in response to the first send routing information message and includes location information of a call forwarding number of the mobile device;
determining at the mobile switching center, in response to the first send routing information acknowledgement message, that a call to the call forwarding number of the mobile device was not answered;
transmitting a second send routing information message from the mobile switching center to the home location register in response to determining that the call to the call forwarding number of the mobile device was not answered; and
processing at the mobile switching center a second send routing information acknowledgement message, wherein the second send routing information acknowledgement message is received from the home location register in response to the second send routing information message and includes location information of the mobile device.

2. The method of claim 1, further comprising:
processing at the mobile switching center, before transmitting the first send routing information message, a first call forwarding override registration message received from the mobile device; and
transmitting, in response to the first call forwarding override registration message, a second call forwarding override registration message from the mobile switching center to the home location register associated with the mobile device.

3. The method of claim 2, wherein the first call forwarding override registration message is a mobile application part register supplementary service message.

4. The method of claim 2, wherein the second call forwarding override registration message is a mobile application part register supplementary service message.

5. The method of claim 1, wherein the first send routing information acknowledgment message comprises a first call forwarding override information element.

6. The method of claim 4, wherein the second send routing information message includes a second call forwarding override information element.

7. The method of claim 1, wherein the call forwarding service is a call forwarding unconditional supplementary service.

8. The method of claim 1, wherein the call forwarding number of the mobile device is associated with a public switched telephone network telephone.

9. The method of claim 1, wherein both the first and second send routing information messages conform to the mobile application part protocol.

10. The method of claim 1, wherein determining that the call to the call forwarding number of the mobile device was not answered comprises determining that a predetermined time period has expired since the call to the call forwarding number was made.

11. A mobile switching center, comprising:
computer readable program code components configured to cause transmitting a first send routing information message from a mobile switching center to a home location register, wherein the send routing information message requests routing information for the mobile device in response to a call to the mobile device;
computer readable program code components configured to cause processing at the mobile switching center a first send routing information acknowledgement message, wherein the first send routing information acknowledgment message is received from the home location register in response to the first send routing information message and includes location information of a call forwarding number of the mobile device;
computer readable program code components configured to cause determining at the mobile switching center, in response to the first send routing information acknowledgement message, that a call to the call forwarding number of the mobile device was not answered;
computer readable program code components configured to cause transmitting a second send routing information message from the mobile switching center to the home location register in response to determining that the call to the call forwarding number of the mobile device was not answered; and
computer readable program code components configured to cause processing at the mobile switching center a second send routing information acknowledgement message, wherein the second send routing information acknowledgement message is received from the home location register in response to the second send routing information message and includes location information of the mobile device.

12. The mobile switching center of claim 11, further comprising:
computer readable program code components configured to cause processing at the mobile switching center, before transmitting the first send routing information message, a first call forwarding override registration message received from the mobile device; and
computer readable program code components configured to cause transmitting, in response to the first call forwarding override registration message, a second call forwarding override registration message from the mobile switching center to the home location register associated with the mobile device.

13. The mobile switching center of claim 12, wherein the first call forwarding override registration message is a mobile application part register supplementary service message.

14. The mobile switching center of claim 12, wherein the second call forwarding override registration message is a mobile application part register supplementary service message.

15. The mobile switching center of claim 11, wherein the first send routing information acknowledgment message comprises a first call forwarding override information element.

16. The mobile switching center of claim 15, wherein the second send routing information message includes a second call forwarding override information element.

17. The mobile switching center of claim 11, wherein the call forwarding service is a call forwarding unconditional supplementary service.

18. The mobile switching center of claim 11, wherein the call forwarding number of the mobile device is associated with a public switched telephone network telephone.

19. The mobile switching center of claim 11, wherein both the first and second send routing information messages conform to the mobile application part protocol.

20. A mobile switching center, comprising:
means for transmitting a first send routing information message from a mobile switching center to a home location register, wherein the send routing information message requests routing information for the mobile device in response to a call to the mobile device;
means for processing at the mobile switching center a first send routing information acknowledgement message, wherein the first send routing information acknowledgment message is received from the home location register in response to the first send routing information message and includes location information of a call forwarding number of the mobile device;
means for determining at the mobile switching center, in response to the first send routing information acknowledgement message, that a call to the call forwarding number of the mobile device was not answered;
means for transmitting a second send routing information message from the mobile switching center to the home location register in response to determining that the call to the call forwarding number of the mobile device was not answered; and
means for processing at the mobile switching center a second send routing information acknowledgement message, wherein the second send routing information acknowledgement message is received from the home location register in response to the second send routing information message and includes location information of the mobile device.
